(19) United States
(12) Patent Application Publication
(10) Pub. No.: US 2025/0079492 A1
(43) Pub. Date: Mar. 6, 2025

(54) PLANT MICROBIAL FUEL CELL

(71) Applicant: National Tsing Hua University, Hsinchu City (TW)

(72) Inventors: Yao-Yu Lin, Hsinchu City (TW); Hsin-Tien Li, Hsinchu City (TW); Heng-An Su, Hsinchu City (TW); Tzu-Yin Liu, Hsinchu City (TW); Han-Yi Chen, Hsinchu City (TW)

(73) Assignee: National Tsing Hua University, Hsinchu City (TW)

(21) Appl. No.: 18/490,745

(22) Filed: Oct. 19, 2023

(30) Foreign Application Priority Data
Sep. 1, 2023 (TW) 112133198

(51) Int. Cl. H01M 8/16; H01M 4/86

(52) U.S. Cl. CPC H01M 8/16; H01M 4/8605

(57) ABSTRACT

A plant microbial fuel cell includes a planting container, a plant, a cathode and an anode. The planting container has a culture medium therein, and a microbial population is in the culture medium. The plant is grown in the culture medium in the planting container. The cathode is disposed on a surface of the culture medium, and the anode is arranged in the culture medium close to roots of the plant. The anode includes a porous carbon material prepared from coffee grounds, and thus the overall cost of the plant microbial fuel cell may be greatly reduced, and the porous carbon material is easy to process and has high biocompatibility.

### CROSS-REFERENCE TO RELATED APPLICATION

This application claims the priority benefit of Taiwan application serial no. 112133198, filed on Sep. 1, 2023. The entirety of the above-mentioned patent application is hereby incorporated by reference herein and made a part of this specification.

### BACKGROUND

### Technical Field

The disclosure relates to a microbial fuel cell (MFC) technology, and in particular to a plant microbial fuel cell (PMFC).

### Description of Related Art

A plant microbial fuel cell technology uses sugary nutrients formed by plant photosynthesis as a supply source for the microbial population near the roots of the plant to perform a decomposition. Electrons are generated during the reaction of decomposing the sugary nutrients, so the power produced by the microorganisms may be collected through an electrode piece disposed at the roots to form a self-power system.

However, the plant microbial fuel cell generally has the issue of low output power. In order to increase the output power, in the current research field of microbial fuel cell, the anode material uses mostly carbon materials with highly biocompatibility as the base material compounded with high-cost nanomaterials having high conductivity.

### SUMMARY

The disclosure provides a plant microbial fuel cell, which may improve a performance of a power density and a biocompatibility while reducing required costs.

A plant microbial fuel cell of the disclosure includes a planting container, a plant, a cathode and an anode. The planting container has a culture medium therein, and a microbial population is in the culture medium. The plant is grown in the culture medium in the planting container. The cathode is disposed on a surface of the culture medium, and the anode is disposed in the culture medium close to roots of the plant. The anode includes a porous carbon material prepared from coffee grounds.

In an embodiment of the disclosure, the cathode includes carbon cloth, graphite felt, carbon felt, graphite paper, carbon paper, graphite brush, carbon brush, stainless steel mesh or nickel foam.

Another plant microbial fuel cell of the disclosure includes a planting container, a plant, a cathode and an anode. The planting container has a culture medium therein, and a microbial population is in the culture medium. The plant is grown in the culture medium in the planting container. The cathode is disposed on a surface of the culture medium, and the anode is disposed in the culture medium close to roots of the plant. The cathode and the anode include a porous carbon material prepared from coffee grounds.

In all embodiments of the disclosure, the anode may further include a conductive plate, and the porous carbon material is coated on the surface of the conductive plate.

In another embodiment of the disclosure, the cathode may further include a conductive plate, and the porous carbon material is coated on the surface of the conductive plate.

In all embodiments of the disclosure, the conductive plate includes carbon cloth, graphite felt, carbon felt, graphite paper, carbon paper, graphite brush, carbon brush, stainless steel mesh or nickel foam.

In all embodiments of the disclosure, the porous carbon material is prepared with an activation weight ratio of the coffee grounds and an activator being 1:1 to 1:5.

In all embodiments of the disclosure, the activator includes NaOH, Na₂CO₃, KOH or K₂CO₃.

In all embodiments of the disclosure, the culture medium includes water, soil, or water and soil.

In all embodiments of the disclosure, the plant includes foliage plants.

In all the embodiments of the disclosure, the microbial population includes Escherichia coli, Shewanella putrefaciens, a diverse microbial system in wastewater sludge or plant growth environment.

Based on the above, the disclosure uses wasted coffee grounds to prepare the porous carbon material with a high surface area and a certain degree of conductivity as an electrode material for the plant microbial fuel cell to replace a traditional higher-cost nanomaterial, so that the cost may be greatly reduced. At the same time, the disclosure uses a biochar electrode made of coffee grounds porous carbon material. The biochar electrode is coated on the anode (conductive) plate commonly used in the existing plant microbial fuel cell, which may not only improve the performance of the power density and the biocompatibility, but also reduce cost the required costs, and may achieve a circular economy of waste recycling.

In order to make the aforementioned features of the disclosure more comprehensible, embodiments accompanied with figures are described in detail below.

### BRIEF DESCRIPTION OF THE DRAWINGS

FIG. 1 is a schematic graph of a plant microbial fuel cell according to an embodiment of the disclosure.

FIG. 2 is a scanning electron micrograph (SEM) of a coffee grounds porous carbon material of Preparation examples 1 to 4.

FIG. 3 is a curve graph of BET specific surface area of Preparation examples 1 to 4 and Comparative preparation example.

FIG. 4A is a distribution curve graph of pore sizes of Preparation examples 1 to 4 and Comparative preparation example.

FIG. 4B is a distribution curve graph of micropores and mesopores of Preparation examples 1 to 4 and Comparative preparation example.

FIG. 5 is a distribution bar graph of pore sizes of Preparation examples 1 to 3 and Comparative Preparation examples.

FIG. 6 is a schematic graph of plant microbial fuel cells of Experimental examples 1 to 4.

FIG. 7 is a curve graph of current density and power density of the microbial fuel cells of Experimental examples 1 to 4.

### DESCRIPTION OF THE EMBODIMENTS

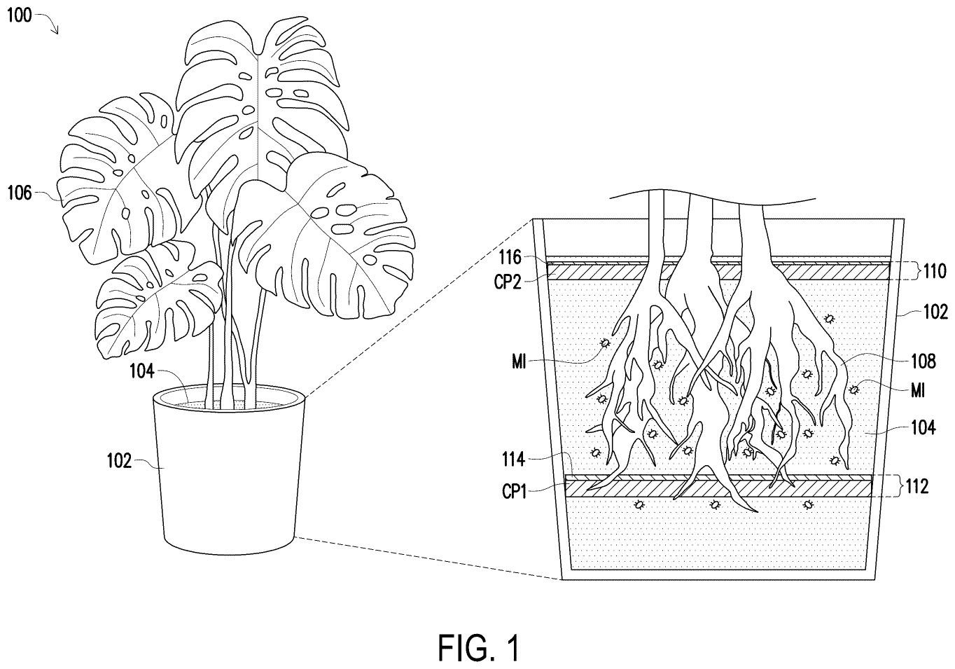

FIG. 1 is a schematic diagram of a plant microbial fuel cell according to an embodiment of the disclosure.

Referring to FIG. 1, the plant microbial fuel cell 100 in the embodiment includes a planting container 102, a plant 106 grown in a culture medium 104 in the planting container 102, a cathode 110 and an anode 112. In one embodiment, the plant 106 may be foliage plants or other suitable plants. The culture medium 104 in the planting container 102 may be water, soil, or water and soil. Furthermore, the culture medium 104 contains a microbial population MI, including, for example, Escherichia coli, Shewanella putrefaciens, a diverse microbial system in wastewater sludge or a plant growth environment. The cathode 110 is disposed on a surface of the culture medium 104; for example, the culture medium 104 in the planting container 102 may be the water and the soil, and a water surface is higher than the soil, so the cathode 110 may be disposed at the interface of the soil and the water. However, the disclosure is not limited thereto. In another embodiment, the cathode 110 may be exposed from the culture medium 104 and exposed to the air. The anode 112 is disposed in the culture medium 104 and close to roots 108 of the plant 106. The anode 112 includes a porous carbon material 114 prepared from coffee grounds (hereinafter also referred to as “coffee grounds porous carbon material”). In an embodiment, the porous carbon material 114 is prepared with an activation weight ratio of the coffee grounds to an activator being 1:1 to 1:5. The activator is such as NaOH, Na₂CO₃, KOH or K₂CO₃. Since the wasted coffee grounds are used to prepare the porous carbon material 114 with a high surface area and a certain degree of conductivity as a material of the anode 112, a traditional higher-cost nanomaterial may be replaced, thereby reducing costs. Moreover, a biochar electrode made of the coffee grounds porous carbon material has a proper biocompatibility and may achieve a circular economy of waste recycling.

In FIG. 1, the anode 112 may also include a conductive plate CP1, and the porous carbon material 114 is coated on the surface of the conductive plate CP1. The conductive plate CP1 is, for example, but not limited to, carbon cloth, graphite felt, carbon felt, graphite paper, carbon paper, graphite brush, carbon brush, stainless steel mesh or nickel foam. The cathode 110 may be a conductive plate CP2, for example, but not limited to, the carbon cloth, the graphite felt, the carbon felt, the graphite paper, the carbon paper, the graphite brush, the carbon brush, the stainless steel mesh or the nickel foam. In addition, a porous carbon material 116 such as a carbon nanotube or an activated carbon may also be coated on the surface of the conductive plate CP2. However, in another embodiment, the cathode 110 may include the porous carbon material 114 prepared from the coffee grounds like the anode 112, which may further reduce the cost of the plant microbial fuel cell 100, and experiments confirm that the plant microbial fuel cell 100 still has an excellent power density.

Experimental examples are described below to verify the efficacy of the invention. However, the invention is not limited to the following content.

### Preparation Examples 1-4

First, a coffee waste (CW) was carbonized at 450° C. for two hours in a nitrogen atmosphere and ball milled. Compositions having the weight ratios of the coffee grounds to an activator NaOH being 1:0, 1:1, 1:3, 1.5, respectively, were then prepared. Then, the composition was activated at 800° C. for two hours in the nitrogen atmosphere, and then pickled and dried to obtain the coffee grounds porous carbon materials of Preparation Example 1 (CWAC-0), Preparation example 2 (CWAC-1), Preparation example 3 (CWAC-3), and Preparation example 4 (CWAC-5).

### Comparative Preparation Example

Commercial activated carbon (CAC) was used as a comparison. The commercial activated carbon is sold by Homy graphite, model G03-Y200-1k.

### <SEM Analysis>

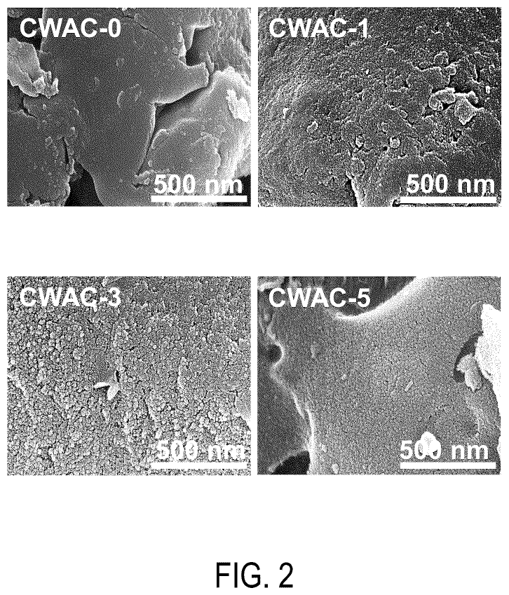

Surface topographies of Preparation examples 1 to 4 were observed by using SEM, and FIG. 2 was obtained.

It may be seen from FIG. 2 that the surface of Preparation example 1 (CWAC-0) was relatively free of pores compared with other preparation examples.

### <BET Analysis>

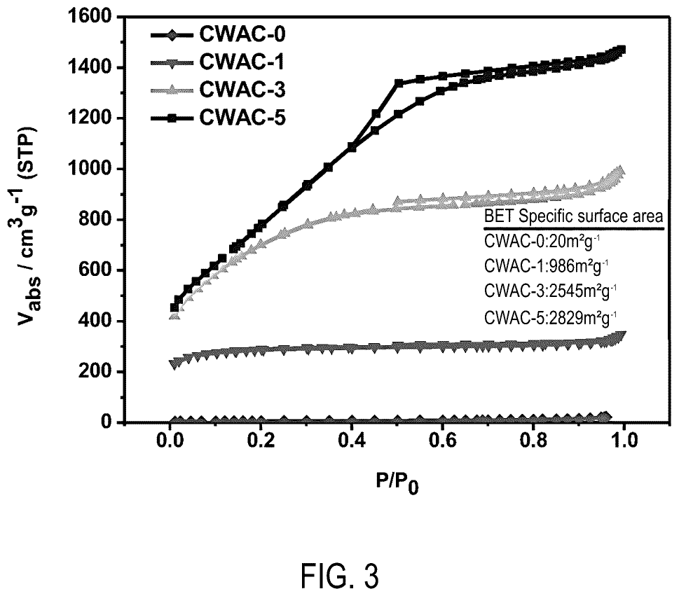

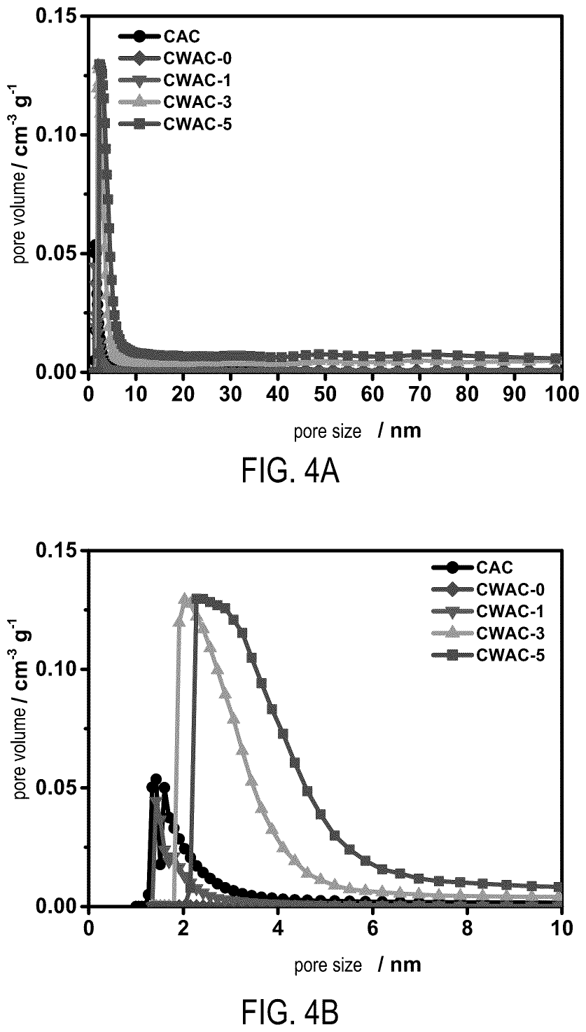

Since the material characteristics such as a pore size distribution and a specific surface area of the coffee grounds porous carbon material may not be known only from the SEM surface topography image, the activated carbons of Preparation examples 1 to 3 and the carbon material of Comparative preparation example 1 were analyzed to obtain the BET specific surface area curve graph of FIG. 3, the pore size distribution curve graph of FIG. 4A, and the distribution curve graph of micropores and mesopores of FIG. 4B. In particular, micropores refer to pore diameter less than 2 nm, mesopores refer to pore diameter between 2 nm and 50 nm.

It may be seen from FIG. 3 that the specific surface area of Preparation example 1 (CWAC-0) is the lowest among Preparation examples 1 to 4, which is only 10 m² g⁻¹. The main reason is that the coffee grounds porous carbon material has not been activated, so there are no activated pores on the surface of Preparation example 1 (CWAC-0). Due to an addition of the activator, the specific surface area of Preparation example 2 (CWAC-1) has increased significantly compared to CWAC-1, which is 988 m² g⁻¹, and is also higher than the commercial activated carbon (CAC). The specific surface areas of Preparation example 3 (CWAC-3) and Preparation example 4 (CWAC-5) are 2244 m² g⁻¹ and 2124 m² g⁻¹, respectively, which are about twice of CWAC-1. Presumably the main reason is an increased ratio of the activator, which allows the activator to cover all materials more effectively, thereby creating more activation surfaces and increasing more specific surface area.

It may be seen from FIG. 4A that the pore size distributions of Preparation examples 1 to 4 and Comparative preparation example all show significantly fewer macropores. Macropores refer to pore diameter greater than 50 nm. It may be seen from FIG. 4B that the amount of micropores is greater than the amount of mesopores in Preparation example 2, while the amount of mesopores is greater than the amount of micropores in Preparation examples 3 to 4.

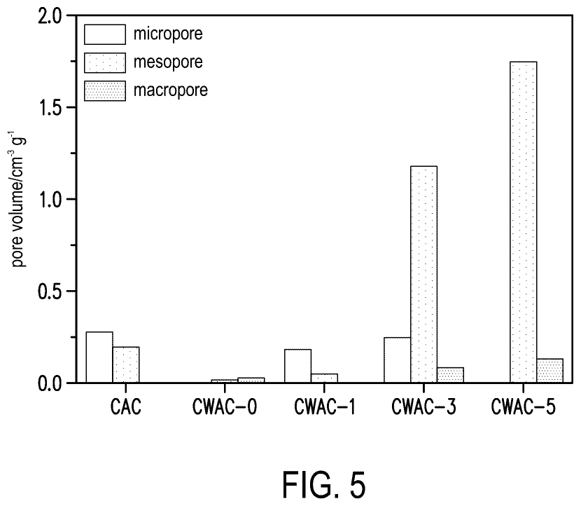

In response to the pore size distribution in FIG. 4A being converted to the distribution of macropores, mesopores, and micropores, FIG. 5 may be obtained. From FIG. 5, the difference between the amount of mesopores and the amount of micropores in Preparation Examples 1 to 4 may be seen more intuitively.

### <Measurement of Water Contact Angle>

Firstly, the coffee grounds porous carbon materials in Preparation examples 1 to 4 were mixed with a conductive additive (carbon black) and an binder (PVDF) into a slurry at the weight ratio of 80:10:10 (stirring for one day), then the slurry was coated on the surface of the graphite felt as a test sample. Then, deionized water of 5 μl was dropped onto the surface of a coating layer of the coffee grounds porous carbon material, and a water contact angle θ was observed. A principle of a contact angle measurement is to measure an angle between the deionized water droplet of 5 μl and the surface of the coating layer. The smaller the water contact angle θ was, the more hydrophilic the surface of the coating layer was, and vice versa.

The measurement results are respectively as follows. The water contact angle of Preparation example 1 (CWAC-0) is 147°. The water contact angle of Preparation example 2 (CWAC-1) is 140°. The water contact angle of Preparation example 3 (CWAC-3) is 112°. The water contact angle of Preparation example 4 (CWAC-5) is 116°. Therefore, Preparation example 3 and Preparation example 4 have proper hydrophilicity.

### <Measurement of Sheet Resistance>

Four-point probe measurements were performed on the above test samples. The measurement results are respectively as follows. The sheet resistance of the commercial activated carbon (CAC) is 1386 mΩ□⁻¹. The sheet resistance of Preparation example 1 (CWAC-0) is 1256 mΩ□⁻¹. The sheet resistance of Preparation example 2 (CWAC-1) is 1105 mΩ□⁻¹. The sheet resistance of Preparation Example 3 (CWAC-3) is 1042 mΩ□⁻¹. The sheet resistance of Preparation Example 4 (CWAC-5) is 832 mΩ□¹. Therefore, Preparation examples 2 to 4 have proper conductivity.

### Experimental Example 1

Firstly, the CAC, the conductive additive (the carbon black), and the binder (polyvinylidene fluoride (PVDF)) were mixed into the slurry at the weight ratio of 80:10:10 (stirring for one day), then the slurry was coated on the graphite felt of 12×12 cm² as the cathode. A hole needed to be cut out on a side of the cathode for the plant to pass through.

Then, the coffee grounds porous carbon material of Preparation example 4 (CWAC-5), the conductive additive (the carbon black) and the binder (PVDF) were also prepared into the slurry at the weight ratio of 80:10:10 (stirring for one day), then the slurry was coated on the graphite felt (the thickness of 5 mm) having a working area of 12 cm×12 cm as the anode.

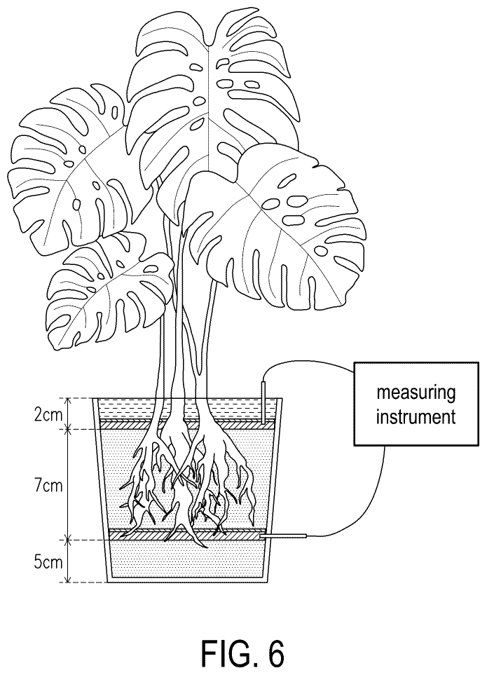

Next, a titanium wire was used to pass through the uncoated surfaces of the cathode and the anode, and then a plant microbial fuel cell (PMFC) was set as shown in FIG. 6 in a way of planting Canna indica in wetland soil by adding tap water. The anode was disposed in the wetland soil adjacent to the root of the Canna indica, and the cathode was disposed at the interface between the wetland soil and the tap water. The anode was about 5 cm away from the bottom of the container, the distance between the anode and the cathode was about 7 cm, and the water surface of the tap water was 3 cm above the cathode.

### Experimental Example 2

The same preparation manner as in Experimental example 1 was used, but the CAC was changed to the coffee grounds porous carbon material of Preparation example 2 (CWAC-1).

### Experimental Example 3

The same preparation manner as in Experimental example 1 was used, but the CAC was changed to the coffee grounds porous carbon material of Preparation example 3 (CWAC-3).

### Experimental Example 4

The same preparation manner as in Experimental example 1 was used, but the CAC was changed to the coffee grounds porous carbon material of Preparation example 4 (CWAC-5).

### <Long-Term Battery Testing>

The PMFC of Experimental examples 1 to 4 was switched to a closed mode. A resistor of 1000Ω was used to connect the cathode and the anode. A measuring instrument was used to measure a cross-voltage of the resistor until a closed circuit voltage (CCV) remained stable. A formula P=The V2/R was used to calculate the corresponding power density to measure a cell voltage and the power density under a long-term operation. No nutrient solution was replenished during the test. A geometric area of the cathode was used in all of the above experiments as the basis for standardization.

On the 10th day of the experiment, a long-term load voltage was measured after an open circuit voltage was stabilized. Specifically, an external resistor of 1000Ω was connected to the cathode and the anode of the PMFC. The voltages of two ends of the external resistor were measured to obtain the long-term load voltage. The corresponding power density was obtained through the formula P=V²/R. According to the result, the long-term load voltage of all parameters of an average voltage may maintain a stable output at about 0.9 volts, except for being less stable due to a few days of external disturbances. The long-term load voltage of CWAC-5//CWAC-5 is slightly lower than the long-term load voltage of CWAC-1//CWAC-3, and is close to the performance of CWAC-5//CAC, but the performance of CWAC-5//CWAC-5 is relatively stable, and the performances of the same parameters in three basins are also relatively close. In addition, a coffee grounds activated carbon was used in each set of the parameters as the coated material of the cathode and the anode. The each set of the parameters may maintain the load voltage in a range of 850 mV to 1200 mV and maintain the power density in the range of 60 mW m⁻² to 70 mW m⁻² more than 20 days.

The following Table 1 is an average value of continuous measurement for 40 days on the PMFC of Experimental examples 1 to 4.

TABLE 1

| Experimental | Average | Average power |
|---|---|---|
| example(anode//cathode) | voltage(mV) | density (mW m⁻²) |
| 1 (CWAC-5//CAC) | 922.9 | 66.7 |
| 2 (CWAC-5//CWAC-1) | 933.1 | 68.3 |
| 3 (CWAC-5//CWAC-3) | 903.2 | 64.2 |
| 4 (CWAC-5//CWAC-5) | 894.6 | 63.4 |

It may be seen from Table 1 that Experimental example 2 has proper average voltage and average power density compared with other experimental examples.

### Experimental Example 5

The same preparation manner as in Experimental Example 1 was used, but CWAC-5 was changed to the coffee grounds porous carbon material of Preparation example 2 (CWAC-1).

### Experimental Example 6

The same preparation manner as in Experimental example 1 was used, but CWAC-5 was changed to the coffee grounds porous carbon material of Preparation example 3 (CWAC-3).

### <Electrochemical Performance>

An analysis method by changing resistance was used to measure polarization curves, the power densities and electrode potentials of the PMFCs of Experimental examples 1 and 5 to 6. 24 hours before measuring the polarization curve, the originally closed PMFC was disconnected. Then, after 24 hours, the open circuit voltage of the PMFC and the potential of the cathode and the anode relative to a reference electrode were recorded. The cathode and the anode of the PMFC were connected with the resistor. The cross-voltage of the resistor and the potential of the electrode relative to the reference electrode were recorded after 20 minutes. A current density and the power density were obtained by calculating the measured voltage and the known resistor.

After the above resistor was measured, the next resistor was connected immediately. That is, there was no time interval between the two resistors. The measuring instrument used in this experiment was a BioLogic potentiostat VSP, and the reference electrode was Ag/AgCl. The resistors were 3.6, 10, 51, 100, 150, 200, 300, 390, 1000 and 3900Ω.

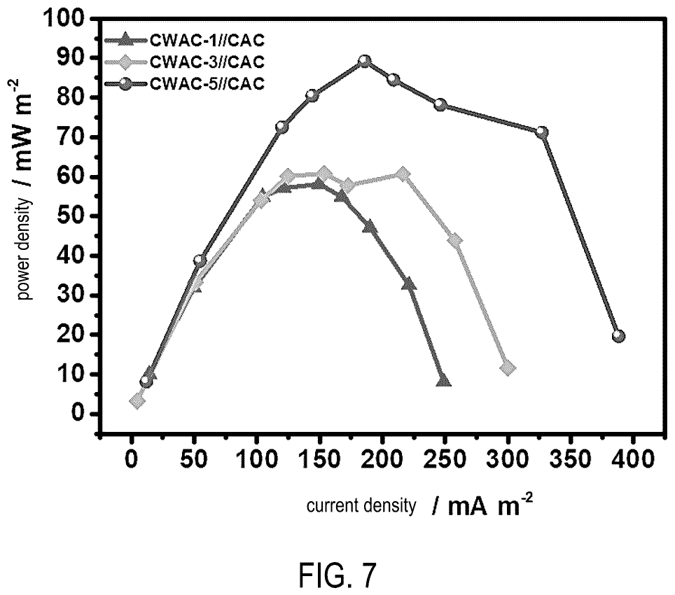

The measurement results are shown in FIG. 7. The current density and the power density are calculated based on the geometric area of the cathode. The maximum current density of Experimental example 1 (CWAC-5//CAC) is approximately 388.2 mA m⁻², while the maximum current densities of Experimental example 5 (CWAC-1//CAC) and Experimental example 6 (CWAC-3//CAC) are respectively 248.8 mA m⁻² and 300.0 mA m⁻². The average maximum power densities of Experimental example 1, Experimental example 5, and Experimental example 6 are 89.3 mW m⁻², 63.2 mW m⁻², and 65.9 mW m⁻², respectively.

The measurement results of the resistors are shown in Table 2 and Table 3.

TABLE 2

| Experimental | Internal | External |
|---|---|---|
| example(anode//cathode) | impedance(Ω) | impedance(Ω) |
| 1 (CWAC-5//CAC) | 148.1 | 166.7 |
| 5 (CWAC-1//CAC) | 228.9 | 233.3 |
| 6 (CWAC-3//CAC) | 185.5 | 166.7 |

It may be obtained from Table 2 that the coffee ground porous carbon material of the disclosure may also enable the PMFC to have good conductivity.

TABLE 3

| | Internal | Anode | External |
|---|---|---|---|
| Experimental | imped- | imped- | imped- |
| example(anode//cathode) | ance(Ω) | ance(Ω) | ance(Ω) |
| 1 (CWAC-5//CAC) | 148.1 | 46.2 | 166.7 |
| 5 (CWAC-1//CAC) | 228.9 | 83.1 | 233.3 |
| 6 (CWAC-3//CAC) | 185.5 | 45.7 | 166.7 |

It may be seen from Table 3 that in measurement of the internal impedance, Experimental example 1 has the lowest internal impedance and the anode impedance. This result facilitates an overall operation of the PMFC.

In summary, the disclosure uses waste coffee grounds to prepare the porous carbon material as an electrode material for the plant microbial fuel cell, and thus greatly reduces costs. At the same time, the use of the coffee grounds porous carbon materials may facilitate a microorganism adhesion of the anode, allowing microorganisms to effectively transfer electrons, and may also provide a long-term power without the need to replenish the nutrient solutions.

The disclosure uses the electrodes prepared by the coffee grounds porous carbon material to coat on an anode (conductive) plate commonly used in the existing plant microbial fuel cell, which may not only improve the performance of the power density and the biocompatibility, but also reduce the required costs, and may achieve the circular economy of waste recycling. The plant microbial fuel cell of the disclosure causes almost no pollution during the operation and may become a sustainable energy.

Although the disclosure has been described with reference to the above embodiments, it will be apparent to one of ordinary skill in the art that modifications to the described embodiments may be made without departing from the spirit of the disclosure. Accordingly, the scope of the disclosure is defined by the attached claims not by the above detailed descriptions.

What is claimed is:

1. A plant microbial fuel cell, comprising:
a planting container, having a culture medium therein, wherein a microbial population is in the culture medium;
a plant, grown in the culture medium of the planting container;
a cathode, disposed on a surface of the culture medium; and
an anode, disposed in the culture medium close to roots of the plant, wherein the anode comprises a porous carbon material prepared from coffee grounds.

2. The plant microbial fuel cell according to claim 1, wherein the cathode comprises carbon cloth, graphite felt, carbon felt, graphite paper, carbon paper, graphite brush, carbon brush, stainless steel mesh or nickel foam.

3. The plant microbial fuel cell according to claim 1, wherein the anode further comprises a conductive plate, and the porous carbon material is coated on a surface of the conductive plate.

4. The plant microbial fuel cell according to claim 3, wherein the conductive plate comprises carbon cloth, graphite felt, carbon felt, graphite paper, carbon paper, graphite brush, carbon brush, stainless steel mesh or nickel foam.

5. The plant microbial fuel cell according to claim 1, wherein the porous carbon material is prepared with an activation weight ratio of the coffee grounds to an activator being 1:1 to 1:5.

6. The plant microbial fuel cell according to claim 5, wherein the activator comprises NaOH, Na₂CO₃, KOH or K₂CO₃.

7. The plant microbial fuel cell according to claim 1, wherein the culture medium comprises water, soil, or water and soil.

8. The plant microbial fuel cell according to claim 1, wherein the plant comprises foliage plants.

9. A plant microbial fuel cell, comprising:
a planting container, having a culture medium therein, wherein a microbial population is in the culture medium;
a plant, grown in the culture medium of the planting container;
a cathode, disposed on a surface of the culture medium; and
an anode, disposed in the culture medium close to roots of the plant, wherein the cathode and the anode comprise a porous carbon material prepared from coffee grounds.

10. The plant microbial fuel cell according to claim 9, wherein the anode further comprises a conductive plate, and the porous carbon material is coated on a surface of the conductive plate.

11. The plant microbial fuel cell according to claim 10, wherein the conductive plate comprises carbon cloth, graphite felt, carbon felt, graphite paper, carbon paper, graphite brush, carbon brush, stainless steel mesh or nickel foam.

12. The plant microbial fuel cell according to claim 9, wherein the cathode further comprises a conductive plate, and the porous carbon material is coated on a surface of the conductive plate.

13. The plant microbial fuel cell according to claim 12, wherein the conductive plate comprises carbon cloth, graphite felt, carbon felt, graphite paper, carbon paper, graphite brush, carbon brush, stainless steel mesh or nickel foam.

14. The plant microbial fuel cell according to claim 9, wherein the porous carbon material is prepared with an activation weight ratio of the coffee grounds and an activator being 1:1 to 1:5.

15. The plant microbial fuel cell according to claim 14, wherein the activator comprises NaOH, Na₂CO₃, KOH or K₂CO₃.

16. The plant microbial fuel cell according to claim 9, wherein the culture medium comprises water, soil, or water and soil.

17. The plant microbial fuel cell according to claim 9, wherein the plant comprises foliage plants.

18. The plant microbial fuel cell according to claim 9, wherein the microbial population comprises Escherichia coli, Shewanella putrefaciens, a diverse microbial system in a wastewater sludge or a plant growth environment.
